(19) United States
(12) Patent Application Publication
(10) Pub. No.: US 2025/0121314 A1
(43) Pub. Date: Apr. 17, 2025

(54) FILTER CLEANING DEVICE

(71) Applicant: KOWA Inc., Ama-shi Aichi (JP)

(72) Inventor: Kazuki NAKAGAWA, Ama-shi Aichi (JP)

(21) Appl. No.: 18/929,610

(22) Filed: Oct. 29, 2024

Related U.S. Application Data
(63) Continuation of application No. PCT/JP2023/017847, filed on May 12, 2023.

(30) Foreign Application Priority Data
May 13, 2022 (JP) 2022-079772

(51) Int. Cl. B01D 46/681; B60H 3/06

(52) U.S. Cl. CPC B01D 46/681; B60H 3/06; B01D 2279/50

(57) ABSTRACT

Provided with a filter cleaning device capable of reducing a manufacturing cost and capable of cleaning a filter frequently each time when a vehicle is used. A filter cleaning device 10 includes: a filter 1; a cleaning body 2 configured to remove dust adhered to a surface of the filter 1 while contacting with the filter 1; and a movable mechanism 3 connected to the cleaning body 2 and configured to control a movement of the cleaning body 2 while keeping a distance between the cleaning body 2 and the filter 1 approximately constant, wherein the movable mechanism 3 enables the cleaning body 2 to move relatively with respect to the filter 1 by an inertia force generated by an acceleration, a deceleration and a steering of a vehicle.

### CROSS-REFERENCE TO RELATED APPLICATIONS

This Application claims the benefit of priority and is a Continuation application of the prior International Patent Application No. PCT/JP2023/017847, with an international filing date of May 12, 2023, which designated the United States, and is related to the Japanese Patent Application No. 2022-079772, filed May 13, 2022, the entire disclosures of all applications are expressly incorporated by reference in their entirety herein.

### TECHNICAL FIELD

The present invention relates to a filter cleaning device provided on a vehicle air conditioner of an automobile or the like.

### BACKGROUND OF THE INVENTION

In a vehicle air conditioner, when an outside air is taken in and conditioned to feed the outside air inside the vehicle, the outside air is supplied inside the vehicle after the outside air is purified through a filter. Since dust included in the outside air is deposited in the filter to cause the clogging of the filter, a cleaning of the filter is required. Similarly, when the inside air is circulated inside the vehicle, the filter is provided for purifying dust generated inside the vehicle. Thus, the cleaning of the dust deposited in the filter is required. The invention of automating the cleaning of the filter is conventionally known (Patent Document 1).

In the vehicle air conditioner disclosed in Patent Document 1, when a glove box is opened for housing small articles, a wire pulls a brush box and a scraping member eliminates foreign materials on the air filter and discharges them from a discharge air duct. When the glove box is closed, the brush box and the scraping member are returned to the original positions by a tensile coil spring.

### PRIOR ART

### Patent Documents

Patent Document 1: Japanese Unexamined Patent Application Publication No. 2007-216712

### SUMMARY OF THE INVENTION

### Problem to be Solved by the Invention

The above described vehicle air conditioner disclosed in Patent Document 1 does not require a motor for driving the scraping member and wiring for supplying electricity to the motor are not required. Thus, the manufacturing cost can be reduced. However, when the glove box is not opened or closed, the dust is still deposited in the filter. There is a problem to cause the clogging of the filter.

The present invention is made for solving the above described conventional problem and aims for providing a filter cleaning device capable of reducing the manufacturing cost without requiring the motor and the electric wiring and capable of cleaning the filter frequently each time when the vehicle is used.

### Means for Solving the Problems

In order to solve the above described problem, the invention of claim 1 is a filter cleaning device provided with a vehicle air conditioner, the filter cleaning device including: a filter; a cleaning body configured to remove dust attached to a surface of the filter while contacting with the filter; and a movable mechanism connected to the cleaning body and configured to control a movement of the cleaning body while keeping a distance between the cleaning body and the filter approximately constant, wherein the movable mechanism enables the cleaning body to move relatively with respect to the filter by an inertia force generated by an acceleration, a deceleration and a steering of a vehicle.

In the invention of claim 1, the movable mechanism is configured to control the cleaning body to move relatively with respect to the filter by the inertia force generated by the acceleration, the deceleration and the steering of the vehicle. Thus, the motor and the electric wiring are not required and the manufacturing cost can be reduced. Since the inertia force generated by the acceleration, the deceleration and the steering of the vehicle is generated each time when the vehicle is used, the filter can be frequently cleaned.

The invention of claim 2 is the invention according to claim 1, wherein the movable mechanism includes: a brush base having a rod shape for holding the cleaning body; and a guide rail configured to slidingly contact with a sliding member formed on both end portions or a center portion of the brush base and support the sliding member, the brush base is configured to reciprocate along a longitudinal direction of the guide rail, and the guide rail is provided near an end portion or a center portion of the filter. Consequently, the inertia force can be converted into the force in the linear direction along the filter to use the inertia force.

The invention of claim 3 is the invention according to claim 2, wherein a buffer device is provided near both end portions of the guide rail in the longitudinal direction, and the buffer device is configured to generate a repulsive force to the brush base when the brush base is approached to the buffer device or contacted with the buffer device for buffering a collision with the guide rail. Consequently, even when large inertia force is applied, the movable mechanism is prevented from being damaged.

The invention of claim 4 is the invention according to claim 2, wherein a first load per unit length of the brush base in the longitudinal direction at a first portion supported by the guide rail near the sliding member is larger than a second load per unit length of the brush base at a second portion other than the first portion near the sliding member. Consequently, the inertia force applied on the brush base can be increased and the deformation of the brush base is suppressed. Thus, the brush base can be slid on the guide rail smoothly.

The invention of claim 5 is the invention according to claim 1, wherein the movable mechanism includes a brush base having a rod shape for holding the cleaning body, and one end of the brush base is rotatably fixed near the filter and the other end of the brush base is a free end which is reciprocally movable. Consequently, the movable mechanism can be simplified and the manufacturing cost can be reduced.

The invention of claim 6 is the invention according to any one of claims 1 to 5, wherein the movable mechanism enables the cleaning body to move in a direction inclined with respect to a travelling direction of the vehicle when the vehicle is seen in a side view. Consequently, even when the inertia force is not applied to the vehicle, a gravitational force is applied to the cleaning body and the cleaning body can be moved to one end side of the filter. Thus, the cleaning body can be prevented from being stopping at an intermediate position of the filter and obstructing ventilation.

The invention of claim 7 is the invention according to claim 1, wherein the movable mechanism includes: a rotation axis; and a brush base having a plate shape for holding the cleaning body, one end of the brush base in a short direction is rotatably fixed to the rotation axis and the other end of the brush base is a free end which is reciprocally movable, and the cleaning body is held on the free end. Consequently, the movable mechanism can be simplified and the manufacturing cost can be reduced.

The invention of claim 8 is a filter cleaning device provided on a vehicle air conditioner, the filter cleaning device including: a filter; a cleaning body configured to remove dust attached to a surface of the filter while contacting with the filter; and a movable mechanism directly or indirectly connected to the filter and configured to control a movement of the filter while keeping a distance between the cleaning body and the filter approximately constant, wherein the movable mechanism enables the filter to move relatively with respect to the cleaning body by an inertia force generated by an acceleration, a deceleration and a steering of a vehicle.

In the invention of claim 8, the movable mechanism is configured to control the filter to move relatively with respect to the cleaning body by an inertia force generated by an acceleration, a deceleration and a steering of a vehicle. Thus, the motor and the electric wiring are not required and the manufacturing cost can be reduced. Since the inertia force generated by the acceleration, the deceleration and the steering of the vehicle is generated each time when the vehicle is used, the filter can be frequently cleaned.

The invention of claim 9 is a filter cleaning device provided on a vehicle air conditioner, the filter cleaning device including: a filter; a cleaning body configured to remove dust attached to a surface of the filter while contacting with the filter; and a movable mechanism having an approximately lid shape configured to control a movement of the cleaning body while keeping a distance between the cleaning body and the filter approximately constant, the movable mechanism being provided on a position facing the filter while sandwiching the cleaning body, wherein the movable mechanism enables the cleaning body to move relatively with respect to the filter by an inertia force generated by an acceleration, a deceleration and a steering of a vehicle.

In the invention of claim 9, the movable mechanism is configured to control the cleaning body to move relatively with respect to the filter by an inertia force generated by an acceleration, a deceleration and a steering of a vehicle. Thus, the motor and the electric wiring are not required and the manufacturing cost can be reduced. Since the inertia force generated by the acceleration, the deceleration and the steering of the vehicle is generated each time when the vehicle is used, the filter can be frequently cleaned.

The invention of claim 10 is the invention according to any one of claims 1, 8 and 9, wherein a dust box is formed at a portion near the filter and at least one of end portions in a moving direction of the cleaning body. Consequently, the dust removed from the filter by the cleaning body can be accumulated in the dust box and the accumulated dust can be collectively discharged to the outside.

### Effects of the Invention

In the invention of claims 1, 8 and 9, the motor and the electric wiring are not required and the manufacturing cost can be reduced. Since the inertia force generated by the acceleration, the deceleration and the steering of the vehicle is generated each time when the vehicle is used, the filter can be frequently cleaned. In the invention of claim 2, the inertia force can be converted into the force in the linear direction along the filter to use the force.

In the invention of claim 3, even when large inertia force is applied, the movable mechanism is prevented from being damaged. In the invention of claim 4, the inertia force applied on the brush base can be increased and the deformation of the brush base is suppressed. Thus, the brush base can be slid on the guide rail smoothly. In the invention of claims 5 and 7, the movable mechanism can be simplified and the manufacturing cost can be reduced.

In the invention of claim 6, the cleaning body can be prevented from being stopping at an intermediate position of the filter and obstructing ventilation. In the invention of claim 10, the dust removed from the filter by the cleaning body can be accumulated in the dust box and the accumulated dust can be collectively discharged to the outside.

### BRIEF DESCRIPTION OF DRAWINGS

FIG. 1A is a cross-sectional view showing a state that a filter cleaning device is installed in a vehicle air conditioner concerning the present invention. FIG. 1B is a perspective view showing the first embodiment of the filter cleaning device concerning the present invention.

FIG. 2A is a side view showing a case where the inertia force is applied backward of the vehicle. FIG. 2B is a side view showing a case where the inertia force is applied frontward of the vehicle.

FIG. 3A is a perspective view of the first embodiment of a cleaning body. FIG. 3B is a perspective view showing the second embodiment of the cleaning body. FIG. 3C is a perspective view showing the third embodiment of the cleaning body. FIG. 3D is a perspective view showing the fourth embodiment of the cleaning body.

FIG. 4A is a cross-sectional view showing the first embodiment of a buffer device. FIG. 4B is a cross-sectional view showing the second embodiment of the buffer device. FIG. 4C is a cross-sectional view showing the third embodiment of the buffer device.

FIG. 5 is a perspective view showing the second embodiment of the filter cleaning device concerning the present invention.

FIG. 6 is a perspective view showing the third embodiment of the filter cleaning device concerning the present invention.

FIG. 7 is a perspective view showing the fourth embodiment of the filter cleaning device concerning the present invention.

FIG. 8 is a perspective view showing the fifth embodiment of the filter cleaning device concerning the present invention.

FIG. 9 is a perspective view showing the sixth embodiment of the filter cleaning device concerning the present invention.

FIG. 10 is a perspective view showing the seventh embodiment of the filter cleaning device concerning the present invention.

### DETAILED DESCRIPTION OF THE INVENTION

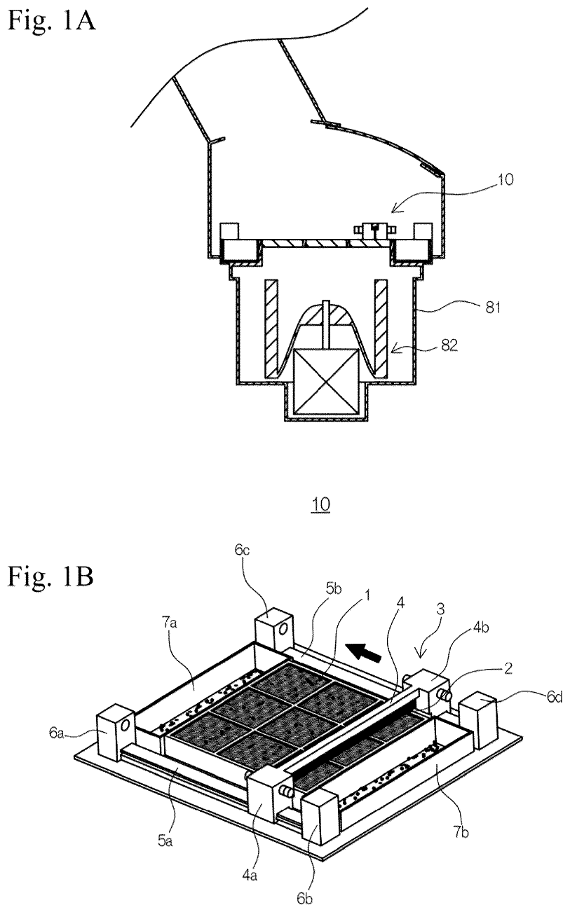

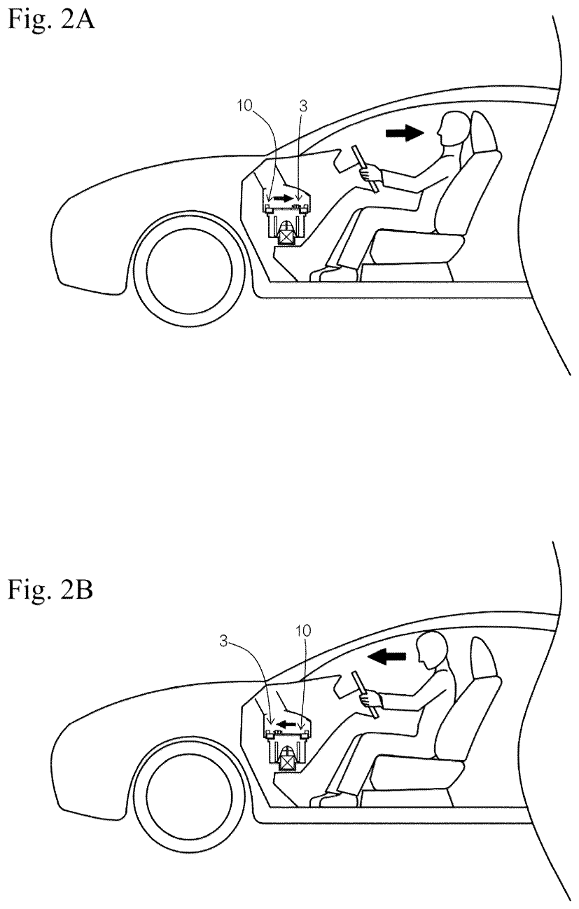

Hereafter, the embodiments of the present invention will be explained with reference to the drawings. Note that the present invention is not limited to the embodiments described below. FIG. 1A is a cross-sectional view showing a state that a filter cleaning device is installed in a vehicle air conditioner concerning the present invention. FIG. 1B is a perspective view showing the first embodiment of the filter cleaning device concerning the present invention. FIG. 2A is a side view showing a case where the inertia force is applied backward of the vehicle. FIG. 2B is a side view showing a case where the inertia force is applied frontward of the vehicle. The first embodiment of the filter cleaning device concerning the preset invention will be explained using the above described drawings.

A filter cleaning device 10 of the first embodiment is installed in a vehicle air conditioner. As shown in FIG. 1A, the filter cleaning device 10 is installed in an upstream side (upper side) of a blower fan 82 installed inside a vehicle air conditioner body case 81. The air passed through a filter 1 is supplied to inside the vehicle.

The filter cleaning device 10 includes a filter 1, a cleaning body 2 configured to remove dust attached to (collected on) a surface of the filter 1 while contacting with the filter the filter 1, a movable mechanism 3 connected to the cleaning body 2 and configured to control a movement of the cleaning body 2 while keeping a distance between the cleaning body 2 and the filter 1 approximately constant.

The movable mechanism 3 enables the cleaning body 2 to move relatively with respect to the filter 1 by an inertia force generated by an acceleration, a deceleration and a steering of the vehicle. Consequently, the motor and the electric wiring are not required and the electricity of the vehicle is not used. Thus, an environmentally friendly structure can be achieved without burdening the power consumption of the whole vehicle and the manufacturing cost can be reduced. Since the inertia force generated by the acceleration, the deceleration and the steering of the vehicle is generated each time when the vehicle is used, the filter 1 can be frequently cleaned.

The movable mechanism 3 includes: a brush base 4 having a rod shape for holding the cleaning body 2; and guide rails 5a, 5b configured to slidingly contact with sliding members 4a, 4b formed on both end portions of the brush base 4 and support the sliding members 4a, 4b. The brush base 4 is configured to reciprocate along a longitudinal direction of the guide rails 5a, 5b. The guide rails 5a, 5b are provided near both end portions of the filter 1. Consequently, the inertia force can be converted into the force in the linear direction along the filter 1 to use the force.

Each of buffer devices 6a, 6b, 6c and 6d is provided near both end portions of the guide rails 5a, 5b in the longitudinal direction. The buffer devices 6a, 6b, 6c and 6d are configured to generate a repulsive force to the brush base 4 when the brush base 4 is approached to the buffer devices 6a, 6b, 6c and 6d or contacted with the buffer devices 6a, 6b, 6c and 6d for buffering a collision of the brush base 4 with the guide rails 5a, 5b. Consequently, even when large inertia force is applied, the movable mechanism 3 is prevented from being damaged.

A first load per unit length of the brush base 4 in the longitudinal direction at a first portion near the sliding members 4a, 4b supported by the guide rails 5a, 5b is larger than a second load per unit length of the brush base 4 at a second portion other than the first portion near the sliding members 4a, 4b. Consequently, the inertia force applied on the brush base 4 can be increased and the deformation of the brush base is suppressed. Thus, the brush base 4 can be slid on the guide rails 5a, 5b smoothly.

Dust boxes 7a, 7b are formed near the filter 1 and both sides of a moving direction of the cleaning body 2. If the dust boxes 7a, 7b are formed on at least one of end portions in a moving direction of the cleaning body 2, such a configuration is included in the present invention. Consequently, the dust removed from the filter 1 by the cleaning body 2 can be accumulated in the dust boxes 7a, 7b and the accumulated dust can be collectively discharged to the outside.

Note that the movable mechanism 3 is preferably configured to move the cleaning body 2 in a direction inclined with respect to a travelling direction of the vehicle when the vehicle is seen in a side view. Consequently, even when the inertia force is not applied to the vehicle, a gravitational force is applied to the cleaning body and the cleaning body can be moved to one of both ends of the filter 1. Thus, the cleaning body 2 can be prevented from being stopping at an intermediate position of the filter 1 and prevented from obstructing ventilation.

Here, the inertia force is the force generated by the acceleration, the deceleration and the steering of the vehicle. When the vehicle is accelerated, as shown in FIG. 2A, the inertia force is applied from the front to the rear of the driver. Thus, the inertia force is also applied to the movable mechanism 3 of the filter cleaning device 10 from the front to the rear. Therefore, the cleaning body 2 located at the vehicular front side of the filter 1 is moved to the vehicular rear side of the filter 1. On the contrary, when the vehicle is decelerated, as shown in FIG. 2B, the inertia force is applied from the rear to the front of the driver. Thus, the inertia force is also applied to the movable mechanism 3 of the filter cleaning device 10 from the rear to the front. Therefore, the cleaning body 2 located at the vehicular rear side of the filter 1 is moved to the vehicular front side of the filter 1. Although not illustrated, the inertia force is generated also when the traveling direction of the vehicle is changed by steering. Thus, the cleaning body 2 can be moved relatively with respect to the filter 1.

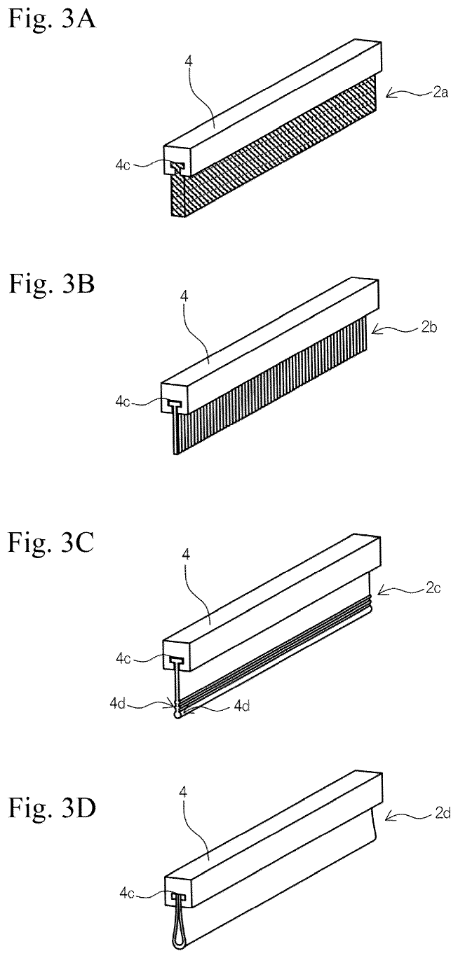

FIG. 3A is a perspective view of the first embodiment of the cleaning body. For convenience, the sliding member of the brush base 4 is not illustrated (same in the following figures). A cleaning body 2a of the first embodiment is formed of a sponge which is a porous synthetic resin body. A base portion formed on one end of the cleaning body 2a is slidably fixed to a groove portion 4c of the brush base 4.

FIG. 3B is a perspective view showing the second embodiment of the cleaning body. A cleaning body 2b of the second embodiment is formed of a bristle material. A base portion formed on one end of the cleaning body 2b is slidably fixed to the groove portion 4c of the brush base 4. Note that various materials such as nylon, PP, PE and natural fiber can be applied as a material of the bristle material.

FIG. 3C is a perspective view showing the third embodiment of the cleaning body. A cleaning body 2c of the second embodiment is formed of a blade made of soft synthetic resin. A base portion formed on one end of the cleaning body 2c is slidably fixed to the groove portion 4c of the brush base 4. Although protrusion protrusions 4d, 4d are formed on side surfaces of the blade shown in FIG. 3C, a blade without having a protrusion can be also used.

FIG. 3D is a perspective view showing the fourth embodiment of the cleaning body. A cleaning body 2d of the fourth embodiment is formed of a non-woven fabric. A base portion formed on one end of the cleaning body 2d is slidably fixed to the groove portion 4c of the brush base 4.

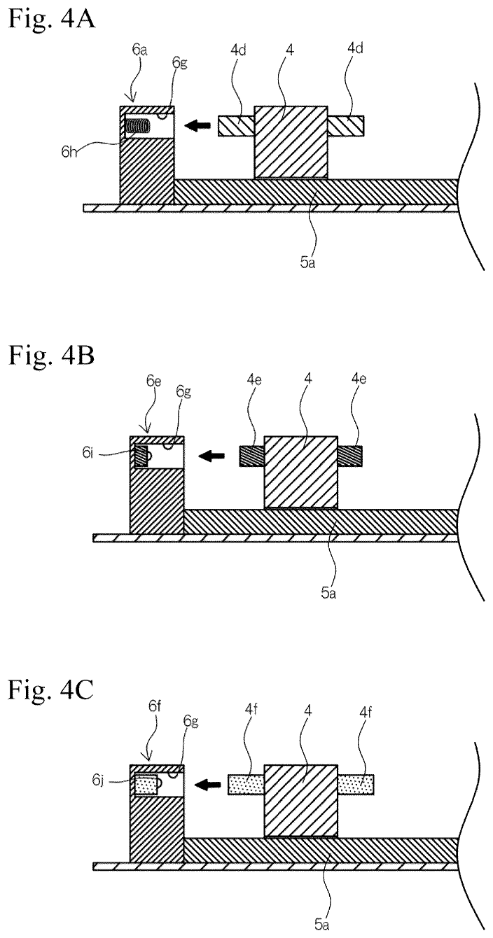

FIG. 4A is a cross-sectional view showing the first embodiment of a buffer device. The buffer device 6a of the first embodiment is provided near both end portions of the guide rail 5a in the longitudinal direction. An insertion hole 6g is formed on a side portion of the buffer device 6a for inserting a projected portion 4d into the insertion hole 6g. In addition, a spring 6h is provided on the insertion hole 6g as a biasing means. When the projected portion 4d of the brush base 4 presses the spring 6h, the projected portion 4d is bounced. Consequently, even when large inertia force is applied, the movable mechanism is prevented from being damaged.

FIG. 4B is a cross-sectional view showing the second embodiment of the buffer device. The buffer device 6e of the second embodiment is provided near both end portions of the guide rail 5a in the longitudinal direction. The insertion hole 6g is formed on a side portion of the buffer device 6e for inserting a projected portion 4e made of a magnet into the insertion hole 6g. In addition, a magnet 6i is provided on the insertion hole 6g. The projected portion 4e side of the magnet 6i has the same magnetic pole as the opposing surface of the projected portion 4e. When the projected portion 4e of the brush base 4 approaches the magnet 6i, the projected portion 4e is bounced. Consequently, even when large inertia force is applied, the movable mechanism is prevented from being damaged.

FIG. 4C is a cross-sectional view showing the third embodiment of the buffer device. The buffer device 6f of the present embodiment is provided near both end portions of the guide rail 5a in the longitudinal direction. The insertion hole 6g is formed on a side portion of the buffer device 6f for inserting a projected portion 4f made of a soft material into the insertion hole 6g. In addition, a cushion member 6j made of a soft material is provided on the insertion hole 6g. When the projected portion 4f of the brush base 4 abuts on the cushion member 6j, the projected portion 4f and the cushion member 6j are deformed for absorbing the impact force. Consequently, even when large inertia force is applied, the movable mechanism is prevented from being damaged.

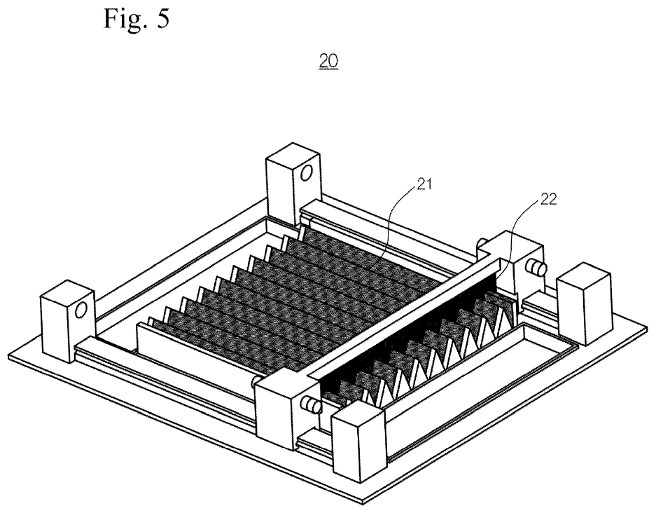

FIG. 5 is a perspective view showing the second embodiment of the filter cleaning device concerning the present invention. In a filter cleaning device 20 of the second embodiment, a pleated filter having a wave shape is used as a filter 21. A tip of a cleaning body 22 is formed in a wave shape corresponding to the shape of the filter 21. Since the pleated filter is adopted, the surface area can be increased and the collection efficiency can be increased. The explanation of the other configurations is omitted since the configurations are the same as the first embodiment.

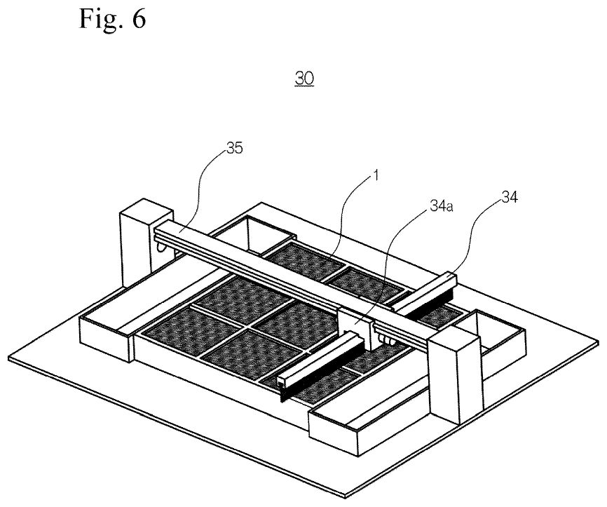

FIG. 6 is a perspective view showing the third embodiment of the filter cleaning device concerning the present invention. In a filter cleaning device 30 of the third embodiment, a guide rail 35 is provided near the center portion of a filter 1 and the sliding member 34a is provided on the center portion of the brush base 34. Consequently, the filter cleaning device 30 can be manufactured at a lower cost than the filter cleaning device 10 of the first embodiment. Thus, the manufacturing cost can be reduced. The explanation of the other configurations is omitted since the configurations are the same as the first embodiment.

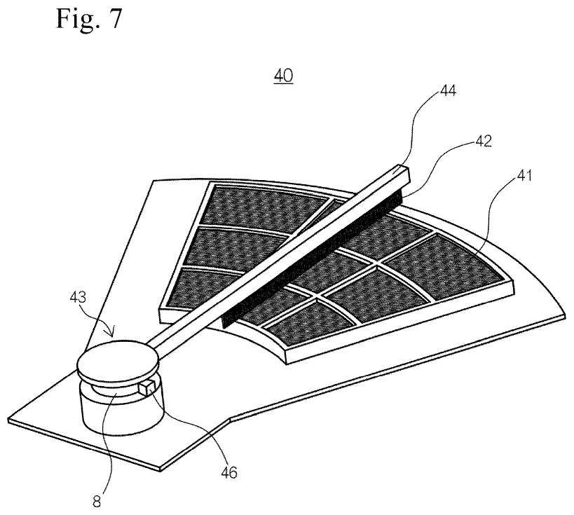

FIG. 7 is a perspective view showing the fourth embodiment of the filter cleaning device concerning the present invention. In a filter cleaning device 40 of the fourth embodiment, a movable mechanism 43 includes a brush base 44 having a rod shape for holding a cleaning body 42. One end of the brush base 44 is rotatably fixed to a shaft body 8 provided on a base near a filter 41 having a fan shape in a plan view. The other end of the brush base 44 is a free end which is reciprocally movable. Note that magnets 46 are provided at two positions of the shaft body 8 and magnets (not illustrated) are provided also on the corresponding brush base 44 so that the faces opposing to each other have the same pole. This functions as the buffer device explained in the first embodiment. Consequently, the movable mechanism 43 can be simplified and the manufacturing cost can be reduced. The explanation of the other configurations is omitted since the configurations are the same as the first embodiment. In this embodiment, the inertia force is generated also when the traveling direction of the vehicle is changed by steering. Thus, the cleaning body 42 is relatively moved with respect to the filter 41.

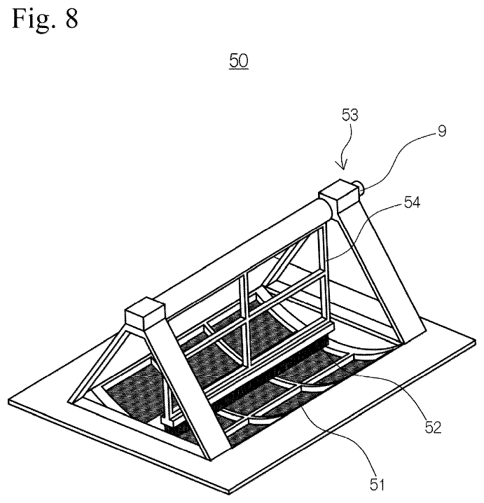

FIG. 8 is a perspective view showing the fifth embodiment of the filter cleaning device concerning the present invention. In a filter cleaning device 50 of the fifth embodiment, a movable mechanism 53 includes: a base provided with a ventilation port in which a filter 51 is provided; a bearing placed on the base; a rotation axis 9 supported by the bearing; and a brush base 54 having a plate shape for holding a cleaning body 52. One end of the brush base 54 in a short direction is rotatably fixed to the rotation axis 9. The other end of the brush base 54 is a free end which is reciprocally movable. The cleaning body 52 is held on the free end. In addition, the filter 51 is formed in an arc shape in a side view. The cleaning is performed when the cleaning body 52 reciprocates on the filter 51 while sliding on the filter 51 by the inertia force generated by the acceleration, the deceleration and the steering of the vehicle. Consequently, the movable mechanism 53 can be simplified and the manufacturing cost can be reduced.

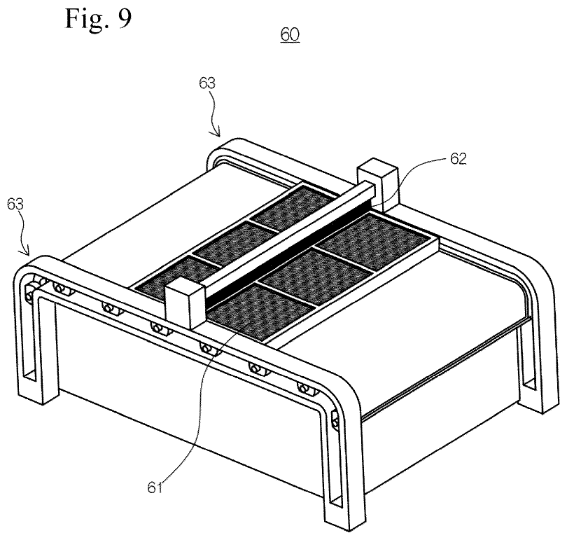

FIG. 9 is a perspective view showing the sixth embodiment of the filter cleaning device concerning the present invention. A filter cleaning device 60 of the sixth embodiment includes: a filter 61; a cleaning body 62 configured to remove dust attached to a surface of the filter 61 while contacting with the filter 61; and a movable mechanism 63 directly or indirectly connected to the filter 61 and configured to control a movement of the filter 61 while keeping a distance between the cleaning body 62 and the filter 61 approximately constant. The movable mechanism 63 is configured to move the filter 61 relatively with respect to the cleaning body 62 by the inertia force generated by the acceleration, the deceleration and the steering of the vehicle. Specifically, a rail having U shape in a side view is provided on both end portions of the filter 61 in the longitudinal direction, and the filter 61 and a belt fixed to both end portions in a short direction of the filter 61 can be moved via a roller. The cleaning is performed when the cleaning body 62 held by the brush base stretched and fixed to an intermediate portion of the left and right rails is slidably contact with the filter 61 reciprocated by the inertia force.

In the filter cleaning device 60 of the sixth embodiment, the movable mechanism is configured to control the filter 61 to move relatively with respect to the cleaning body 62 using the inertia force generated by the acceleration, the deceleration and the steering of the vehicle. Thus, the motor and the electric wiring are not required and the manufacturing cost can be reduced. In addition, the inertia force generated by the acceleration, the deceleration and the steering of the vehicle occurs each time when the vehicle is used. Thus, the filter 61 can be frequently cleaned.

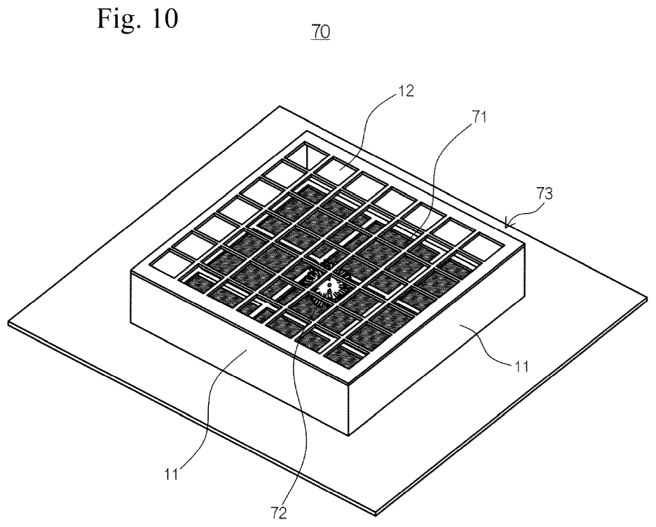

FIG. 10 is a perspective view showing the seventh embodiment of the filter cleaning device concerning the present invention. A filter cleaning device 70 of the seventh embodiment includes: a filter 71; a cleaning body 72 configured to remove dust attached to a surface of the filter 71 while contacting with the filter 71; and a movable mechanism 73 having an approximately lid shape and a ventilation hole 12 configured to control a movement of the cleaning body 72 while keeping a distance between the cleaning body 72 and the filter 71 approximately constant, the movable mechanism 72 being provided on a position facing the filter 71 while sandwiching the cleaning body 72. The movable mechanism 73 is configured to move the cleaning body 72 relatively with respect to the filter 71 by the inertia force generated by the acceleration, the deceleration and the steering of the vehicle. In addition, four sides of the filter 71 are surrounded by the side walls 11, 11 of the base having a ventilation hole in which the filter 71 is installed. Thus, the cleaning body 72 is prevented from being removed from the filter 71.

In the filter cleaning device 70 of the seventh embodiment, the movable mechanism 73 having an approximately lid shape is configured to control the cleaning body 72 to move relatively with respect to the filter 71 using the inertia force generated by the acceleration, the deceleration and the steering of the vehicle. Thus, the motor and the electric wiring are not required and the manufacturing cost can be reduced. In addition, the inertia force generated by the acceleration, the deceleration and the steering of the vehicle occurs each time when the vehicle is used. Thus, the filter 71 can be frequently cleaned. In this embodiment, the inertia force is generated also when the traveling direction of the vehicle is changed by steering. Thus, the cleaning body 72 is relatively moved with respect to the filter 71.

In the drawings showing the above described fourth to seventh embodiments, the dust boxes are not illustrated. However, it is possible to form the dust boxes at a portion near the filter and at least one of end portions in a moving direction of the cleaning body similar to the first to third embodiments.

### INDUSTRIAL APPLICABILITY

The filter cleaning device of the present invention is used by being installed in a vehicle air conditioner of an automobile or the like.

### DESCRIPTION OF THE REFERENCE NUMERALS

1, 21, 41, 51, 61, 71: filter;
2, 2a, 2b, 2c, 2d, 22, 42, 52, 62, 72: cleaning body;
2e: protrusion;
3, 43, 53, 63, 73: movable mechanism;
4, 34, 44, 54: brush base;
4a, 4b, 34a: sliding member;
4c: groove portion;
4d, 4e, 4f: projected portion;
5a, 5b, 35: guide rail;
6a, 6b, 6c, 6d, 6e, 6f: buffer device;
6g: insertion hole;
6h: spring (biasing means);
6i, 46: magnet;
6j: cushion member;
7a, 7b: dust box;
8: shaft body;
9: rotation axis;
10, 20, 30, 40, 50, 60, 70: filter cleaning device;
11: side wall;
12: ventilation hole;
81: vehicle air conditioner body case;
82: blower fan

1. A filter cleaning device provided on a vehicle air conditioner, the filter cleaning device comprising:
a filter;
a cleaning body configured to remove dust attached to a surface of the filter while contacting with the filter; and
a movable mechanism connected to the cleaning body and configured to control a movement of the cleaning body while keeping a distance between the cleaning body and the filter approximately constant, wherein
the movable mechanism enables the cleaning body to move relatively with respect to the filter by an inertia force generated by an acceleration, a deceleration and a steering of a vehicle.

2. The filter cleaning device according to claim 1, wherein
the movable mechanism includes: a brush base having a rod shape for holding the cleaning body; and a guide rail configured to slidingly contact with a sliding member formed on both end portions or a center portion of the brush base and support the sliding member,
the brush base is configured to reciprocate along a longitudinal direction of the guide rail, and
the guide rail is provided near an end portion or a center portion of the filter.

3. The filter cleaning device according to claim 2, wherein
a buffer device is provided near both end portions of the guide rail in the longitudinal direction, and
the buffer device is configured to generate a repulsive force to the brush base when the brush base is approached to the buffer device or contacted with the buffer device for buffering a collision with the guide rail.

4. The filter cleaning device according to claim 2, wherein
a first load per unit length of the brush base in the longitudinal direction at a first portion near the sliding member supported by the guide rail is larger than a second load per unit length of the brush base at a second portion other than the first portion near the sliding member.

5. The filter cleaning device according to claim 1, wherein
the movable mechanism includes a brush base having a rod shape for holding the cleaning body, and
one end of the brush base is rotatably fixed near the filter and the other end of the brush base is a free end which is reciprocally movable.

6. The filter cleaning device according to claim 1, wherein
the movable mechanism enables the cleaning body to move in a direction inclined with respect to a travelling direction of the vehicle when the vehicle is seen in a side view.

7. The filter cleaning device according to claim 1, wherein
the movable mechanism includes: a rotation axis; and a brush base having a plate shape for holding the cleaning body,
one end of the brush base in a short direction is rotatably fixed to the rotation axis and the other end of the brush base is a free end which is reciprocally movable, and the cleaning body is held on the free end.

8. A filter cleaning device provided on a vehicle air conditioner, the filter cleaning device comprising:
a filter;
a cleaning body configured to remove dust attached to a surface of the filter while contacting with the filter; and
a movable mechanism directly or indirectly connected to the filter and configured to control a movement of the filter while keeping a distance between the cleaning body and the filter approximately constant, wherein
the movable mechanism enables the filter to move relatively with respect to the cleaning body by an inertia force generated by an acceleration, a deceleration and a steering of a vehicle.

9. A filter cleaning device provided on a vehicle air conditioner, the filter cleaning device comprising:
a filter;
a cleaning body configured to remove dust attached to a surface of the filter while contacting with the filter; and
a movable mechanism having an approximately lid shape configured to control a movement of the cleaning body while keeping a distance between the cleaning body and the filter approximately constant, the movable mechanism being provided on a position facing the filter while sandwiching the cleaning body, wherein
the movable mechanism enables the cleaning body to move relatively with respect to the filter by an inertia force generated by an acceleration, a deceleration and a steering of a vehicle.

10. The filter cleaning device according to claim 1, wherein
a dust box is formed at a portion near the filter and at least one of end portions in a moving direction of the cleaning body.
